(19) United States
(12) Patent Application Publication
(10) Pub. No.: US 2005/0032617 A1
(43) Pub. Date: Feb. 10, 2005

(54) Roller member

(75) Inventors: Shinobu Hasegawa, Kanagawa (JP); Michiaki Ito, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: HOKUSHIN CORPORATION

(21) Appl. No.: 10/920,348

(22) Filed: Aug. 18, 2004

Related U.S. Application Data
(63) Continuation-in-part of application No. 09/833,815, filed on Apr. 13, 2001.

(30) Foreign Application Priority Data
Apr. 13, 2000 (JP) 2000-112458
Mar. 8, 2001 (JP) 2001-065471

(51) Int. Cl. B25F 5/00; B05C 11/00

(52) U.S. Cl. 492/56; 492/59; 492/48

(57) ABSTRACT

This invention provides a roller member including a metallic core roller 3 and a substantially unshrinkable sleeve 4 having a thermally-induced inner diameter shrinkage of 3.0% or less, which unshrinkable sleeve 4 is applied onto the core roller with interference fit and is heat-welded directly onto the surface of the roller, wherein the unshrinkable sleeve 4 is formed from an elastomer material, and has a Young's modulus of 120-200 MPa and a thickness 50-200 μm. The roller member exhibits improved cleaning characteristics, among other characteristics.

### CROSS-REFERENCE TO RELATED APPLICATION

This application is a Continuation-in-Part of pending application Ser. No. 09/833,815, filed Apr, 13, 2001.

### BACKGROUND OF THE INVENTION

1. Field of the Invention

The present invention relates to a roller member which can be used for imparting a charge, eliminating a charge, or removing toner adhered onto the surface of a transfer belt or a transfer-conveyor belt, in any of a variety of OA apparatuses such as copy machines and printers.

2. Background Art

In a typical electrophotography process, a photosensitive substance is subjected to several processes, including charge-imparting, exposure, development, transfer, and cleaning. In such an electrophotography process, because the toner is charged in reverse, and also because of defects or stains present on the surface of a transfer member, or unsatisfactory transfer, toner cannot be completely transferred onto a transfer medium, and remains on the surface of the transfer member to some extent. Since such residual toner impedes formation of a clear copy image in an electrophotography process in the next cycle, a cleaning process must be carried out after the transfer process.

In a conventional cleaning process, a cleaning blade having an elastic rubber member such as urethane rubber and a metallic holder, the rubber member being fixed onto the holder, is physically brought into contact with a rotating transfer belt; a space between the transfer belt and the cleaning blade is eliminated to thereby prevent toner from passing through the space; and toner which remains on the transfer belt is scraped off.

Alternatively, toner adhered onto a transfer belt is removed by transferring the toner onto a metallic roller, and the toner transferred onto the surface of the metallic roller is scraped off by bringing a cleaning blade into contact with the metallic roller.

However, in the aforementioned cleaning process, toner is not removed efficiently. Due to such low efficiency, toner filming tends to occur on the transfer belt, and thus the service life of the transfer belt may be reduced.

### SUMMARY OF THE INVENTION

In view of the foregoing, an object of the present invention is to provide a roller member exhibiting enhanced durability, as well as improved cleaning characteristics and charge-imparting or charge-eliminating characteristics.

Accordingly, the present invention provides a roller member comprising a metallic core roller and a substantially unshrinkable sleeve having a thermally-induced inner diameter shrinkage of 3.0% or less, which unshrinkable sleeve is applied onto the core roller by means of interference fit and is heat-welded directly onto the surface of the core roller, wherein the unshrinkable sleeve is formed from an elastomer material, and has a Young's modulus of 120-200 MPa and a thickness of 50-200 μm.

The unshrinkable sleeve may be formed from a material selected from the group of polyamides, polyamide elastomers, fluorine-containing polymer compounds, and fluorine-containing elastomers.

The welding force between the core roller and the unshrinkable sleeve may be 0.1 kg/cm or more.

The unshrinkable sleeve may have a surface resistivity of 10⁶ to 10¹² Ω/□.

The unshrinkable sleeve may have a surface roughness (Rz) of 5 μm or less.

The unshrinkable sleeve may have a thickness of 30-200 μm.

The unshrinkable sleeve may have an inner diameter smaller than the outer diameter of the core roller.

The material of the core roller is not particularly limited, but the roller is preferably formed from a metal such as SUS or SUM.

### BRIEF DESCRIPTION OF THE DRAWING

Various other objects, features, and many of the attendant advantages of the present invention will be readily appreciated as the same becomes better understood with reference to the following detailed description of the preferred embodiments when considered in connection with the accompanying drawing, in which:

FIG. 1 is a schematic representation showing an embodiment of the roller member of the present invention.

### DETAILED DESCRIPTION OF PREFERRED EMBODIMENTS

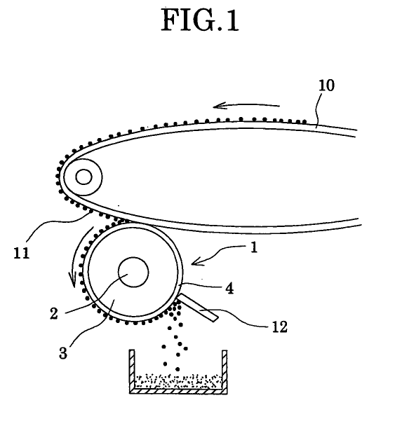

FIG. 1 shows an embodiment of the roller member of the present invention. As shown in FIG. 1, a roller member 1 is provided so as to be brought into close proximity with a transfer belt or a transfer-conveyor belt 10, and the roller member 1 serves as a cleaning roller for cleaning the surface of the transfer belt or the transfer-conveyor belt 10. Specifically, the roller member 1 of the present invention includes a core roller 3 having a shaft 2 in its center, and an unshrinkable sleeve 4 provided on the surface of the core roller 3. When a charge is imparted to the unshrinkable sleeve 4, toner 11 adhered onto the surface of the transfer belt 10 is transferred onto the roller member 1, to thereby reliably remove the toner from the surface of the transfer belt 10 and clean the belt 10. The toner 11 adhered onto the roller member 1 is scraped off, for example, by bringing the surface of the roller member 1 into physical contact with a cleaning blade 12 formed from, for example, an elastic material.

The unshrinkable sleeve 4 may be joined with the core roller 3 through heat-welding; i.e., the sleeve 4 is joined with the core roller 3 without application of an adhesive. Therefore, the unshrinkable sleeve 4 is welded onto the core roller 3 without the intervention of an adhesive layer, and thus efficiency in transfer (i.e., removal or cleaning) of toner can be enhanced. Furthermore, extra steps, such as application of an adhesive, can be omitted.

The unshrinkable sleeve 4 employed in the roller member 1 of the present invention has a Young's modulus of 120-200 MPa, and is substantially unshrinkable. As used herein, the expression “substantially unshrinkable” or “unshrinkable” means that the sleeve has an inner diameter shrinkage of 3.0% or less; in other words, the inner diameter of the sleeve reduces by 3.0% or less when heat is applied thereto. A sleeve having an inner diameter shrinkage in excess of 3.0% is difficult to heat-weld onto the surface of a core roller with good dimensional precision, and therefore, when a core roller having such a sleeve is used as a cleaning roller, excessive stress is induced to thereby produce strain or creases, possibly preventing satisfactory toner transcription or cleaning.

In this context, the term “inner diameter shrinkage” is a percent shrinkage in the circumferential direction of the sleeve (i.e., along the circumference of a cross section of the sleeve when the sleeve is cut vertical to the longitudinal direction thereof) as determined on the basis of measurements obtained by use of a thermomechanical analyzer (TMA) set in a tensile mode. More specifically, the inner diameter shrinkage is calculated from a minimum value of elongation of the sleeve which is measured under the following conditions. Sample length: 10 mm; load: 2 g; temperature elevation rate: 2° C./min.

The material of the unshrinkable sleeve 4 must be an elastomer or elastomer-like material, rather than a resin. Thus, the unshrinkable sleeve 4 is preferably formed from a polyamide (PA), a polyamide elastomer (PAE), or a fluorine-containing polymer compound or fluorine-containing elastomer, such as PFA, PTFE, or ETFE. When the Young's modulus of the unshrinkable sleeve 4 is in excess of the above range, toner particles may be crushed by the sleeve, whereas when the Young's modulus is below the above range, the durability of the sleeve may be lowered.

The surface resistivity of the unshrinkable sleeve 4 is preferably 10⁶ to 10¹² Ω/□. When the surface resistivity falls outside this range, toner may fail to be transferred onto the roller member satisfactorily; i.e., the toner may fail to be removed from the transfer belt or the belt may fail to be cleaned.

The surface roughness (Rz) of the unshrinkable sleeve 4 is preferably 5 μm or less. When the surface roughness is in excess of 5 μm, the sleeve may cause damage to a contact target or the blade abutting the roller member.

The unshrinkable sleeve 4 is heat-welded onto the surface of the core roller 3, and the welding force between the core roller 3 and the unshrinkable sleeve 4 is preferably 0.1 kg/cm or more, more preferably 0.2 kg/cm or more.

The unshrinkable sleeve 4 may have an inner diameter smaller than the outer diameter of the core roller 3, and the core roller 3 is pressed into the sleeve 4 and coated therewith. This is because, when the inner diameter of the unshrinkable sleeve 4 is larger than the outer diameter of the core roller 3, the aforementioned welding force cannot be obtained.

According to the roller member 1 of the present invention, the unshrinkable sleeve 4 exhibits excellent charge-imparting characteristics with respect to toner, and thus efficiency in transfer (i.e., removal or cleaning) of toner adhered onto a transfer belt is enhanced. Specifically, when the unshrinkable sleeve 4 is formed from a polyamide or polyamide elastomer, efficiency in transfer (i.e., removal or cleaning) of toner is enhanced, since an amido group contained in such a compound has high affinity to toner. Also, when the unshrinkable sleeve 4 is formed from a fluorine-containing polymer compound or fluorine-containing elastomer, efficiency in transfer (i.e., removal or cleaning) of toner is enhanced, since a fluorine atom contained in such a compound has high affinity to toner.

The roller member of the present invention is used as a cleaning roller for removing toner adhered onto a transfer belt or a transfer-conveyor belt. In addition, the roller member may be used as a charge-eliminating roller or a charge-imparting roller.

### EXAMPLES

The present invention will next be described in more detail by way of Examples.

### Example 1

A core roller was formed from stainless steel (SUS). The core roller was coated with an unshrinkable sleeve having a thickness of 100 μm, a Young's modulus of 140 MPa, a surface resistivity of 10⁹ Ω/□, and an inner diameter shrinkage of 2.0%. The resultant core roller was heated at 162° C. for 60 minutes, to thereby heat-weld the sleeve onto the core roller and produce a roller member.

### Example 2

The procedure of Example 1 was repeated, except that an unshrinkable sleeve having a Young's modulus of 180 MPa, a surface resistivity of 10¹² Ω/□, and an inner diameter shrinkage of 1.0% was used, to thereby produce a roller member.

### Example 3

A core roller was formed from stainless steel (SUS). The core roller was interference-fitted with an unshrinkable sleeve having a thickness of 100 μm, a Young's modulus of 140 MPa, a surface resistivity of 10¹⁰ Ω/□, and an inner diameter shrinkage of 1.0%. The resultant core roller was heated at 160° C. for 60 minutes, to thereby heat-weld the sleeve onto the core roller and produce a roller member.

### Example 4

The procedure of Example 3 was repeated, except that an unshrinkable sleeve having a Young's modulus of 160 MPa, a surface resistivity of 10¹⁰ Ω/□, and an inner diameter shrinkage of 2.5% was used, to thereby produce a roller member.

### Comparative Example 1

A metallic roller formed from SUS was used as a comparative roller member.

### Comparative Example 2

A core roller was formed from stainless steel (SUS). The core roller was interference-fitted with an unshrinkable sleeve having a thickness of 100 μm, a Young's modulus of 130 MPa, a surface resistivity of 10⁷ Ω/□, and an inner diameter shrinkage of 3.5%. The resultant core roller was heated at 160° C. for 60 minutes, to thereby heat-weld the sleeve onto the core roller and produce a roller member.

### Test Example

The roller member of each of the Examples 1 and 2 and Comparative Example was installed in a copy machine and used as a roller for cleaning a transfer belt. A durability test in which a text was printed out a predetermined number of times was performed, to thereby evaluate the degree of removal of toner adhered onto the transfer belt. The results are shown in Table 1. After having undergone the durability test, each of the roller members produced in Examples 1 to 4 and Comparative Example 2 was inspected for surface conditions. The results are shown in Table 2. Toner transferred onto the roller member was scraped off by use of a conventional cleaning blade.

TABLE 1

Copied sheet count
(times)

| | 1,000 | 5,000 | 10,000 | 50,000 |
|---|---|---|---|---|
| Example 1 | AA | AA | AA | BB |
| Example 2 | AA | AA | AA | BB |
| Example 3 | AA | AA | AA | BB |
| Example 4 | AA | AA | AA | BB |
| Comparative | AA | BB | BB | CC |
| Example 1 | | | | |
| Comparative | BB | BB | CC | CC |
| Example 2 | | | | |

AA: excellent, BB: good, CC: toner remains on the belt

TABLE 2

Copied sheet count
(times)

| | 1,000 | 5,000 | 10,000 | 50,000 |
|---|---|---|---|---|
| Example 1 | AA | AA | AA | BB |
| Example 2 | AA | AA | AA | BB |
| Example 3 | AA | AA | AA | BB |
| Example 4 | AA | AA | AA | BB |
| Comparative | AA | BB | BB | CC |
| Example 1 | | | | |
| Comparative | BB | BB | CC | CC |
| Example 2 | | | | |

AA: excellent, BB: good, CC: strain and creases generate

As shown in Table 1, when the roller member of Example 1 or 2 is used, toner adhered onto the transfer belt is satisfactorily removed, even after a text was printed out 50,000 times. In contrast, when the roller member of Comparative Example is used, toner remains on the transfer belt after the text was printed out 50,000 times, although toner adhered onto the belt is satisfactorily removed when the text was printed out as many as 10,000 times. The roller member of Comparative Example 2 was no longer able to remove toner successfully after the text had been printed out in a number of 5,000 sheets or thereabouts.

Also, as shown in Table 2, the surface conditions of the roller members of Examples 1 to 4 were found to remain good even after a 50,000-sheet durability test. In contrast, when the roller member of Comparative Example 2 was used, the surface conditions were relatively good until printing was repeated 1,000 times or thereabouts, but after the print-out count reached about 5,000 sheets, generation of strain and creases was observed on the sleeve provided on the roller.

The test results clearly indicate that the roller member of the present invention having a core roller and a nonshrinkable sleeve thereon exhibits improved durability and enhanced performance for removal of toner adhering on a transfer belt, etc., as compared with a conventional roller member having a core roller and a shrinkable sleeve thereon.

As described above, the roller member of the present invention exhibits excellent charge-imparting characteristics with respect to toner, and thus exhibits enhanced performance for removal of toner. In addition, toner filming does not occur easily, and durability of the roller member is enhanced.

1. A roller member comprising a metallic core roller and a substantially unshrinkable sleeve having a thermally-induced inner diameter shrinkage of 3.0% or less, which unshrinkable sleeve is applied onto the core roller by means of interference fit and is heat-welded directly onto the surface of the core roller, wherein the unshrinkable sleeve is formed from an elastomer material, and has a Young's modulus of 120-200 MPa and a thickness of 50-200 μm.

2. A roller member according to claim 1, wherein the unshrinkable sleeve is formed from a material selected from the group of polyamides, polyamide elastomers, fluorine-containing polymer compounds, and fluorine-containing elastomers.

3. A roller member according to claim 1, wherein the welding force between the core roller and the unshrinkable sleeve is 0.1 kg/cm or more.

4. A roller member according to claim 1, wherein the unshrinkable sleeve has a surface resistivity of 10⁶ to 10¹² Ω/□.

5. A roller member according to claim 1, wherein the unshrinkable sleeve has a surface roughness (Rz) of 5 μm or less.

6. A roller member according to claim 1, wherein the unshrinkable sleeve has an inner diameter smaller than the outer diameter of the core roller.
